(19) United States
(12) Patent Application Publication
(10) Pub. No.: US 2004/0111534 A1
(43) Pub. Date: Jun. 10, 2004

(54) Method for synchronizing network nodes in a subnetwork

(76) Inventors: Rupert Maier, Eggolsheim (DE); Ralf Sykosch, Weilersbach (DE)

Correspondence Address: HARNESS, DICKEY & PIERCE, P.L.C., P.O.BOX 8910, RESTON, VA, 20195, US

(21) Appl. No.: 10/655,023

(22) Filed: Sep. 5, 2003

(30) Foreign Application Priority Data
Sep. 6, 2002 (DE) 10241429.7

(51) Int. Cl. G06F 15/16

(52) U.S. Cl. 709/248

(57) ABSTRACT

A method for synchronizing the timers of the network nodes in a network to the precise microsecond, where at least one of the network nodes undertakes the function of the network master in a subnetwork and the time on the master is used as a reference time for the subnetwork which is to be synchronized. The master first causes no unauthorised communication to take place in the subnetwork during the subsequent method steps. The master sends a delay-time measurement message to every network node in the subnetwork in order to ascertain the signal delay time, the master then sends a time setting message to every network node, and finally the time on the network nodes is aligned with the reference time for the subnetwork, preferably on a step-by-step basis.

The present application hereby claims priority under 35 U.S.C. §119 on German patent application number DE 102 41 429.7 filed Sep. 6, 2002, the entire contents of which are hereby incorporated herein by reference.

### FIELD OF THE INVENTION

The present invention generally relates to a method for synchronizing network nodes in a subnetwork, where the network nodes have timers and at least one of the network nodes undertakes the function of a master, the time on the master being used as the reference time for the subnetwork.

### BACKGROUND OF THE INVENTION

In industrial plants, for example, data processing devices used, inter alia, for recording measured values, for analyzing measured data and for controlling and/or regulating are normally coupled to a network by way of network nodes. It is known practice to synchronize individual network nodes using universal time signals, such as the signals in the GPS system or the signals in a radio clock. The aforementioned signals currently cannot be received all the time and in all locations, however, receiving them requires installation of specific hardware components, and inaccuracies can arise on account of multipath propagation, for example.

### SUMMARY OF THE INVENTION

It is an object of the present invention to provide a method of synchronizing network nodes in a subnetwork.

An object of the present invention is achieved by providing a method for synchronizing network nodes in a subnetwork. In particular, a master advantageously stores the signal delay time for the network nodes. When the method is repeated, it is thus possible to dispense with the resending of delay-time measurement messages, with repetition of the method preferably involving the presupposition that the network topography does not change and the repetition is made within a relatively short period of time.

It is expedient for a network node, on receiving a delay-time measurement message, to simulate the alignment of its time with the reference time at least once, but preferably twice, and then to send a response to the master. The accuracy of the synchronization operation can be increased in this manner, since the master can thus take into account the period of time required for setting the correct time as part of the signal delay time.

The time on a network node is advantageously aligned with the reference time for the subnetwork immediately after reception of the time setting message. In this way, the periods of time within which network nodes run with an asynchronous time are kept as short as possible.

The time on a network node is advantageously aligned with the reference times for the subnetwork on a step-by-step basis. This alignment can also take place fluently, for example. In contrast to abrupt time alignment, this avoids any disruption of processes which are regulated or controlled using devices connected to the network nodes, for example. Such a procedure is also extremely expedient for analyzing measured data.

Advantageously, at least part of the method is repeated a plurality of times if appropriate in order to achieve greater accuracy. In this case, it is particularly expedient that the master ascertains the signal delay time by sending a plurality of delay-time measurement messages and using formation of an average. This allows minimization of the effects of any remaining delay-time fluctuations, for example.

The network node which undertakes the function of the master in a subnetwork advantageously ascertains all the network nodes which are part of the subnetwork.

At least one network node in a subnetwork advantageously undertakes the function of the master in another subnetwork. In this way, the efficiency of synchronization is increased particularly when there are widely branched networks or when networks have a particularly large number of network nodes or when various groups of network nodes are coupled using different media.

Advantageously, network nodes in a subnetwork are connected on one another by way of an optical transmission medium. On account of the properties of such media, such as optical fibers, and particularly on account of their lack of susceptibility to interference, highly accurate synchronization into the microsecond range is made possible.

Further scope of applicability of the present invention will become apparent from the detailed description given hereinafter. However, it should be understood that the detailed description and specific examples, while indicating exemplary embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a schematic illustration of network nodes arranged in a plurality of subnetworks;

FIG. 2 illustrates an example of the arrangement of network nodes in a subnetwork;

FIGS. 3 and 4 illustrate method steps illustrated by way of example using flowcharts; and

FIG. 5 illustrates an exemplary illustration of the alignment of the time on a network node.

### DETAILED DESCRIPTION OF EXEMPLARY EMOBODIMENTS

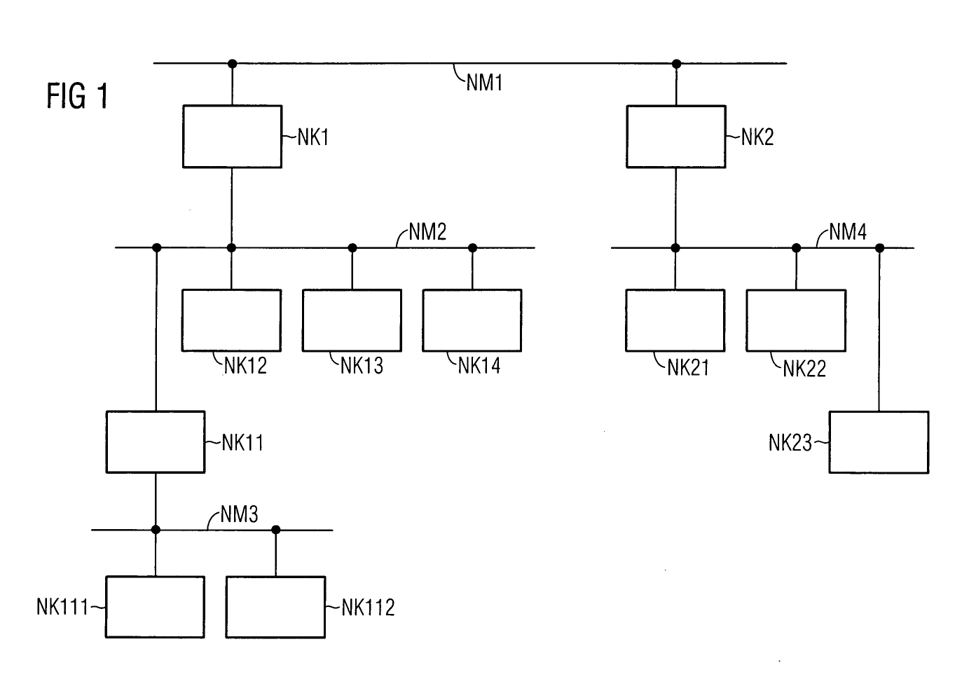

FIG. 1 illustrates a network which includes network nodes NK1, NK2, NK11 to NK14, NK21 to NK23, NK111 and NK112 and also the network media NM1 to NM4. The network media NM1 to NM4 can have further network nodes (not shown in the drawing) connected to it.

Network media are characterized by a transmission medium and a transmission protocol. Examples of transmission media which are used are optical fibers, one or more cables and at least one radio interface. Transmission protocols can be the TCP/IP protocol, for example, or specific protocols for optical transmission media. Network media can preferably be based on the IEEE1394 standard or could be in the form of an Ethernet, for example.

In this case, by way of example, the network nodes NK1, NK11 to NK14 with the network medium NM2 form one subnetwork. Another subnetwork is formed by the network nodes NK11, NK111, NK112 and the network medium NM3, for example. The network nodes NK2 and NK21 to NK23 with the network medium NM4 also form a subnetwork.

Another possible example of a subnetwork within the context of the present invention also includes the network nodes NK1, NK11 to NK14, NK111, NK112 and the network media NM2 and NM3, for example. A subnetwork within the context of the invention is also formed by the network nodes NK1 to NK2, NK11 to NK14, NK21 to NK23 and the network media NM1, NM2 and NM4.

A subnetwork within the context of the present invention can be understood to mean either an entire, preferably closed network, e.g. a local area network, or just part of such a network.

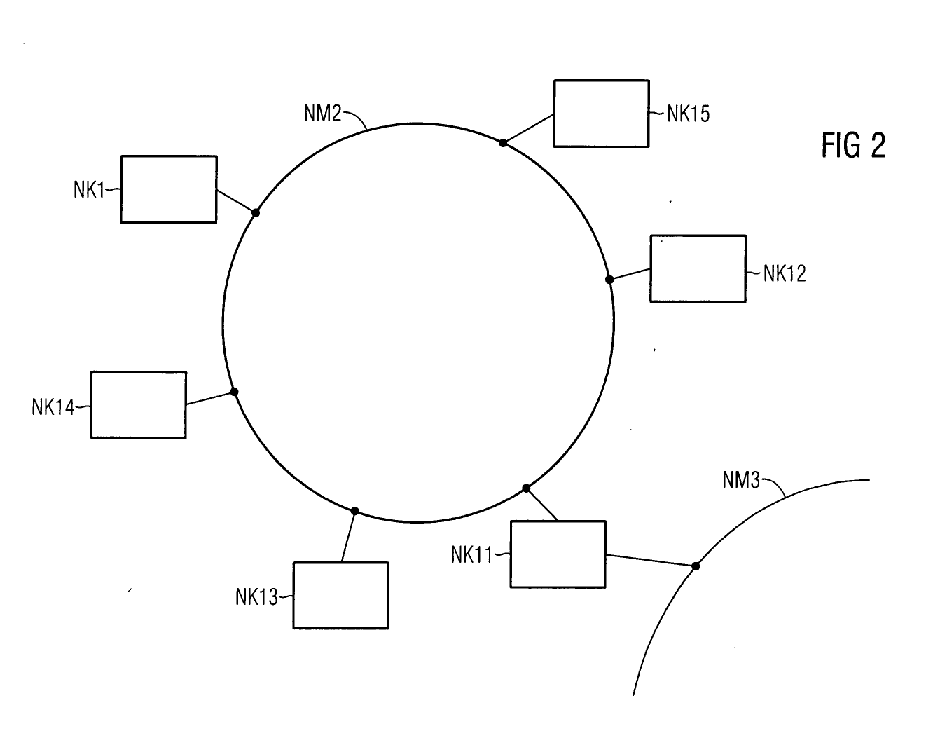

FIG. 2 shows a subnetwork which includes the network nodes NK1 and NK11 to NK15 and the network medium NM2. The network node NK11 and other network nodes (not shown in the drawing) form another subnetwork with the network medium NM3. The subnetwork with the network medium NM2 has a ring-shaped topology, with the network medium NM2 preferably in the form of an optical transmission medium with an appropriate protocol, particularly in the form of an optical fiber.

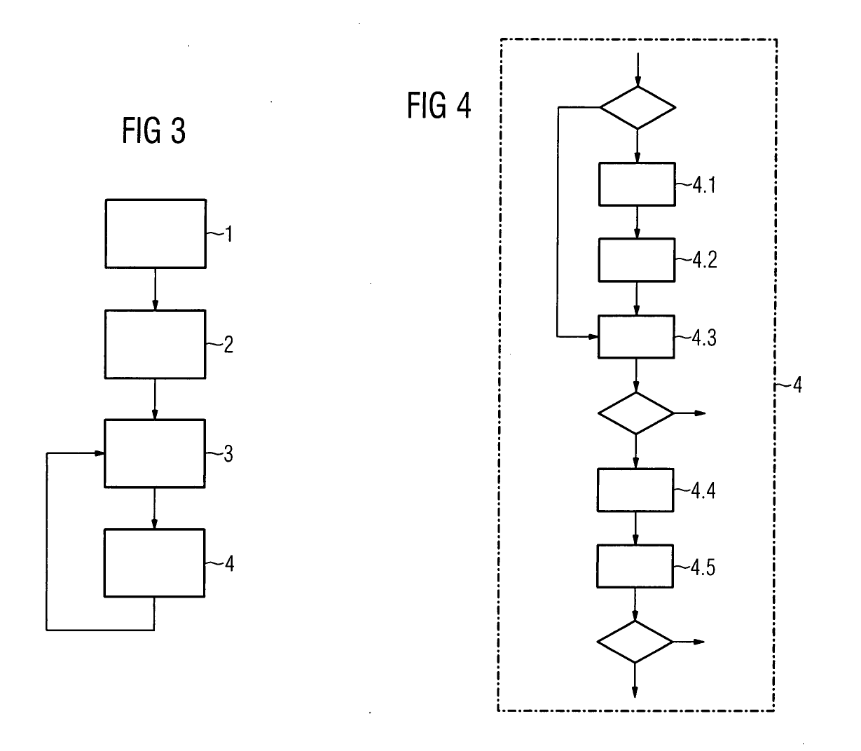

FIG. 3 shows the flow of the inventive method using steps 1 to 4 by way of example. Before the actual synchronization operation the master of the subnetwork which is to be synchronized is negotiated in step 1. By way of example, a master can be negotiated by virtue of the master being determined on the basis of the network topology. A master can also be negotiated by virtue of the network nodes, on initialization, possibly even when there is a reset or at a stipulated time, sending a message in which they offer to be the master, and the fastest sender of such a message then being determined as the master.

For the example shown in FIG. 1, it is subsequently assumed that the network node NK1 undertakes the function of the master for the network comprising the network nodes NK1, NK2 and NK11 to NK14. In line with step 2 of the flowchart shown in FIG. 3, the master NK1 ascertains all the other network nodes NK2 and NK11 to NK14 which are part of the subnetwork which is to be synchronized by it.

For the example shown in FIG. 2, the network node NK1 will likewise undertake the function of the master for the subsequent explanations. This network node is connected to the network node NK11 to NK15 by way of the network medium NM2, which is in the form of an optical fiber. By sending a message using the ring-shaped network medium NM2 in line with step 2 of the flowchart shown in FIG. 3, the master ascertains the addresses of the rest of the network nodes NK11 to NK15.

In line with FIG. 3, in the next step 3, the master sends a message to all the network nodes in the subnetwork which it is to synchronize instructing the nodes not to send any more messages without a request until further notice. In this manner, unauthorized communication in the subnetwork remains stopped, preferably until the end of the synchronization operation, i.e. preferably until the conclusion of step 4. Particularly with network media whose structure is similar to the Internet, such as network media operating using the TCP/IP protocol, it is important for no unauthorized data interchange to take place during the synchronization operation, in order to ensure that it is always possible to determine transmission times and paths.

Next, the actual synchronization operation starts, which is shown as step 4 in FIG. 3. Step 4 is explained in more detail below with reference to FIG. 4. Steps 3 and 4 are repeated, preferably cyclically, with the periodicity of the repetitions being able to be dependent on the accuracy of the timers in the network nodes NK1, NK2, NK11 to NK15, NK21 to NK23, NK111, NK112. It is also possible for steps 3 and 4 to be repeated as required.

The sequence, shown in FIG. 4, of the actual synchronization of the network nodes is divided into a plurality of steps 4.1 to 4.5 and 4.3 to 4.5.

In a first step 4.1, the master of the subnetwork sends a delay-time measurement message to every network node in the subnetwork. Each individual network node is successively addressed and requested to send an acknowledgement to the master immediately. When the acknowledgement has been received by the master, the next network node is addressed. In doing this, the master records the time which elapses between the sending of the respective delay-time measurement message and receipt of the associated acknowledgement.

Preferably, the network node receiving a delay-time measurement message initially simulates transfer of a time value to its timer twice and only then sends its acknowledgement to the master.

Accordingly, in step 4.2, the master can preferably use the recorded time tm, that is to say the time which has elapsed between sending of the delay-time measurement message and arrival of the acknowledgement, taking into account the time t_{f} required for transmitting the delay-time measurement message to the network node, the time tᵣ for transmitting the acknowledgement from the network node to the master, and the time setting time t_{c}, to calculate the signal delay time tₛ as:

$${t}_{ s} = \frac{{t}_{ m}}{2} = \frac{{t}_{ f} + 2 \cdot {t}_{ c} + {t}_{ r}}{2} . \qquad ( 1 )$$

When the signal delay time ts has been calculated in step 4.2, the transmission times for the network nodes are stored in a list with the network master in step 4.3. Preferably when steps 4.1 and 4.2 have not been carried out immediately beforehand, the signal delay times tₛ are retrieved from the master's memory in step 4.3 before the time setting messages are sent in step 4.4.

In a subsequent step 4.4, the master sends time setting messages to the network nodes. The time tₜ transmitted with a time setting message is preferably the network's reference time t_{M} corrected by the signal delay time tₛ, the reference time t_{M} corresponding to the master's time:

t_{T}=t_{M}+tₛ (2)

When the time setting message has been received, the time on the corresponding network node is immediately set again in step 4.5 and synchronized with the reference time t_{M}.

If one of the network nodes NK11 to NK14 (see example from FIG. 1) being synchronized by a master NK1 is connected to another subnetwork, then this network node NK11 preferably undertakes the function of the master in the subnetwork connected to it and synchronizes the rest of the network nodes NK111 and NK112 forming part of the subnetwork. In this way, particularly a widely branched network can be efficiently synchronized.

To eliminate the effects of any remnant delay-time fluctuations, for example steps 4.1 to 4.5 and 4.1 to 4.3 and 4.3 to 4.5 can also be repeated a plurality of times. If this involves using formation of an average when ascertaining the signal delay time tₛ, particularly in steps 4.1 to 4.3, the accuracy of the method can be increased still further.

If steps 3 and 4 shown in FIG. 3 are repeated very often, it is also possible to dispense with steps 4.1 and 4.2 shown in FIG. 4 for individual repetitions, if appropriate, in order to shorten the synchronization operation.

In line with the invention, it is both possible for steps 4.1 to 4.5 to be initially executed in succession network node by network node, possibly even in part, and for individual or groups of steps 4.1 to 4.5 to be executed step by step for all the network nodes.

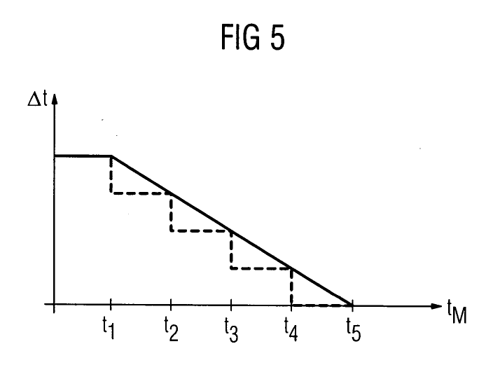

FIG. 5 illustrates how the timer setting in line with step 4.5 is preferably made not abruptly but rather in a continuous or step-by-step transition to the reference time. If, by way of example, the time on a network node at a time t has a time difference Δt with respect to the reference time t_{M} on the master node in the subnetwork and if this difference Δt is detected upon the arrival of a time setting message at the time t₁, the Δt does not need to be reduced abruptly to zero at the time t₁, but rather could either be smoothly changed to zero up to the time t₅ or can be reduced to zero step by step at the times t₁, t₂, t₃, t₄. Step-by-step reduction of Δt can be achieved, by way of example, by virtue of an upper limit for the change in Δt being prescribed when the time on a network node is set.

The present invention allows highly accurate synchronization of network nodes into the range of microseconds without disrupting operation of devices which are connected to the network nodes. The network synchronization can be implemented without any great hardware or software complexity and is of outstanding significance particularly for the recording of measured values and measurement automation, since its accuracy governs the quality of the respective measurement result and ultimately the quality of the product.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for synchronizing network nodes in a subnetwork, where the network nodes have timers and at least one of the network nodes undertakes the function of a master, the time on the master being used as the reference time for the subnetwork, the method comprising:
insuring no unauthorized communication takes place in the subnetwork;
sending a delay-time measurement message to every network node in the subnetwork in order to ascertain a signal delay time;
sending a time setting message to every network node; and
aligning the time on the network nodes with the reference time for the subnetwork,
wherein each of the first three method steps are performed my by the master.

2. The method as claimed in claim 1, further comprising storing the signal delay time for the network nodes in the master.

3. The method as claimed in claim 1, wherein a network node, upon receiving a delay-time measurement message, simulates the alignment of a time thereof with the reference time at least once, and then sends a response to the master.

4. The method as claimed in claim 1, wherein the time on a network node is aligned with the reference time for the subnetwork immediately after reception of the time setting message.

5. The method as claimed in claim 1, wherein the time on a network node is aligned with the reference time for the subnetwork by way of a step-by-step basis.

6. The method as claimed in claim 1, wherein at least one step is repeated a plurality of times.

7. The method as claimed in claim 6, characterized in that the master ascertains the signal delay time by sending a plurality of delay-time measurement messages and using formation of a mean.

8. The method as claimed in claim 1, wherein the master ascertains all the network nodes which are part of the subnetwork.

9. The method as claimed in claim 1, wherein at least one network node in a subnetwork undertakes the function of the master in another subnetwork.

10. The method as claimed in claim 1, wherein the network nodes in a subnetwork are connected to one another by way of an optical transmission medium.

11. The method as claimed in claim 2, wherein a network node, upon receiving a delay-time measurement message, simulates the alignment of a time thereof with the reference time at least once, and then sends a response to the master.

12. The method as claimed in claim 2, wherein the time on a network node is aligned with the reference time for the subnetwork immediately after reception of the time setting message.

13. The method as claimed in claim 3, wherein the time on a network node is aligned with the reference time for the subnetwork immediately after reception of the time setting message.

14. The method as claimed in claim 2, wherein the time on a network node is aligned with the reference time for the subnetwork by way of a step-by-step basis.

15. The method as claimed in claim 3, wherein the time on a network node is aligned with the reference time for the subnetwork by way of a step-by-step basis.

16. The method as claimed in claim 4, wherein the time on a network node is aligned with the reference time for the subnetwork by way of a step-by-step basis.

17. The method as claimed in claim 2, wherein the master ascertains all the network nodes which are part of the subnetwork.

18. The method as claimed in claim 3, wherein the master ascertains all the network nodes which are part of the subnetwork.

19. The method as claimed in claim 4, wherein the master ascertains all the network nodes which are part of the subnetwork.

20. The method as claimed in claim 5, wherein the master ascertains all the network nodes which are part of the subnetwork.

21. The method as claimed in claim 2, wherein at least one network node in a subnetwork undertakes the function of the master in another subnetwork.

22. The method as claimed in claim 3, wherein at least one network node in a subnetwork undertakes the function of the master in another subnetwork.

23. The method as claimed in claim 4, wherein at least one network node in a subnetwork undertakes the function of the master in another subnetwork.

24. The method as claimed in claim 5, wherein at least one network node in a subnetwork undertakes the function of the master in another subnetwork.

25. The method as claimed in claim 8, wherein at least one network node in a subnetwork undertakes the function of the master in another subnetwork.

26. A method, comprising:
insuring no unauthorized communication takes place in a subnetwork;
sending a delay-time measurement message to every network node in the subnetwork in order to ascertain a signal delay time;
sending a time setting message to every network node; and
aligning the time on the network nodes with the reference time for the subnetwork.
